(19) United States
(12) Patent Application Publication
(10) Pub. No.: US 2024/0202513 A1
(43) Pub. Date: Jun. 20, 2024

(54) Compact CMOS Spiking Neuron Circuit that works with an Analog Memory-Based Synaptic Array

(71) Applicant: The University of Hong Kong, Hong Kong (CN)

(72) Inventors: Can Li, Hong Kong (CN); Zhu Wang, Hong Kong (CN); Song Wang, Hong Kong (CN); Hayden So, Hong Kong (CN)

(73) Assignee: The University of Hong Kong, Hong Kong (CN)

(21) Appl. No.: 18/537,246

(22) Filed: Dec. 12, 2023

Related U.S. Application Data
(60) Provisional application No. 63/432,788, filed on Dec. 15, 2022.

(51) Int. Cl. G06N 3/065; G06N 3/049

(52) U.S. Cl. CPC G06N 3/065; G06N 3/049

(57) ABSTRACT

An all-analog spiking neural network circuit including at least one ReRAM-crossbar synapse array that conducts multiply-accumulate operations in parallel and a spike response model (SRM) neuron circuit, which is built with complementary metal-oxide-semiconductor (CMOS) technology. The neuron circuits receive outputs from the ReRAM-crossbar synapse array and directly process the output currents from the ReRAM-crossbar synapse arrays to complete the multiply-accumulate operation and produce processed voltage spike trains.

### CROSS-REFERENCE TO RELATED PATENT APPLICATIONS

This application claims the benefit of priority under 35 U.S.C. Section 119(e) of U.S. Application No. 63/432,788 filed Dec. 15, 2022, which is incorporated herein by reference in its entirety.

### FIELD OF THE INVENTION

The present invention relates a CMOS analog integrated circuit that can function as an artificial neuromorphic network and, more particularly, to such a CMOS circuit that connects directly with artificial synaptic networks that are made of analog memory arrays.

### BACKGROUND OF THE INVENTION

Spiking neural networks (SNNs) have been proposed to replicate the spatiotemporal information processing observed in biological neural systems more faithfully than traditional artificial neural networks (ANNs). Unlike ANNs, which process and transmit information in the form of levels for abstracted mathematical models, SNNs process and communicate information in sparse spike trains. This approach closely resembles the information processing of the nervous system in the brain. Consequently, SNNs implemented in hardware typically exhibit higher energy efficiency than their ANN counterparts, making them particularly suitable for applications where energy is limited and spatiotemporal reasoning is required, such as autonomous vehicle guidance [1], [2] and brain-machine interfaces [3], [4]. Most existing SNNs are emulated on digital hardware, for example, CPUs, GPUs or FPGAs, however the translation overhead to digital representations results in high energy consumption. To address this issue, several SNNs accelerators, known as neuromorphic systems, have been proposed and demonstrated [5]-[10] since the concept was first introduced by Carver Mead in 1990[11]. Neuromorphic systems are naturally suitable for implementation in analog hardware because of their similarities with biological neural systems, characterized by asynchronous operation and the ability to leverage device physics to perform essential functions such as excitatory and inhibitory synapses, spike integration, membrane potential leakage and inhibition, thresholding, and spike firing and transmission. As a result, neuromorphic systems can operate faster and more efficiently than their digital and mixed-signal counterparts.

Recently, many emerging memories/devices and materials have been explored as potential candidates for implementing the biologically-inspired neuromorphic systems with high energy efficiency, such as ReRAM or memristors [12]-[14], phase change materials [15], Gaussian heterojunction transistors [16], ferroelectric field-effect transistors [17], silicon-on-insulator metal-oxide-semiconductor field-effect transistors [18], [19], memtransistors [20], carbon nanotube transistors [21], and 2D MoS2 transistors [22]. These designs aim to leverage biologically plausible physical characteristics exhibited by the emerging memories/devices and employ bio-inspired unsupervised localized synaptic learning rules, such as spike timing-dependent plasticity for training. However, due to the limited understanding of biological neural systems, the accuracy of these systems built from the bottom-up falls short of competitiveness, thereby restricting their practical utility to implement elementary tasks, such as the classification of a small set of letters composed of a limited number of pixels. Additionally, present designs based on emerging memories suffer from limited endurance, making their practical implementation challenging at this stage. Various efforts have been made to build the system by converting ANNs to SNNs through neural coding [23]-[26], which allows SNNs to attain accuracy levels similar to those of state-of-the-art (SOTA) ANNs. However, the additional coding diminishes the inherent advantages of SNNs by introducing considerable latency and energy consumption, and is prone to conversion approximation errors. Another recent success involved applying backpropagation [27]-[29], the cornerstone of ANN training methods, to directly train SNNs. This is achieved through employing surrogate gradients, allowing this method to achieve accuracy levels competitive with SOTA ANN models. However, executing these SNN inference computations on digital von-Neumann hardware, such as CPUs and GPUs, is considerably inefficient, due to the computational complexity of temporal dynamics. Efficient hardware implementations have yet to be reported.

In an article entitled “An ultra-low power sigma-delta neuron circuit,” https://www.researchgate.net/publication/331222752, MOSFETs are disclosed that are used in a neuron design that operate in the subthreshold domain. However, this prior-art neuron is difficult to speed up to a time scale of or within nanoseconds because it would require capacitance approaching or smaller than the parasitic capacitance of integrated circuits.

U.S. Pat. No. 6,242,988 also discloses a neuron design that uses a MOSFET as a switch to inhibit the voltage on the capacitor, and hence the firing. However, this method imposes a minimum limit on the spike width to avoid incomplete resetting of the circuit neuron following each firing. As a consequence, the operational speed of this design is restricted to the scale of seconds.

The article “Leaky Integrate and Fire Neuron by Charge-Discharge Dynamics in Floating-Body MOSFET,” Scientific Reports, 7:8257, 2017 discloses the use of the floating-body effect in partially depleted silicon-on-insulator MOSFET to implement the spiking-neuron operations, i.e., integration, leaking, firing, and resetting. However, this approach necessitates the use of an external control circuit to reset the neuron for tens of nanoseconds after each firing, which restricts its operational speed in the time scale of microseconds.

### SUMMARY OF THE INVENTION

The present invention is an all-analog hardware SNN that can achieve spatiotemporal reasoning in the N-MNIST dataset [30] with an accuracy comparable to SOTA ANN algorithms, while preserving significantly low latency and high energy efficiency. The concept is validated on physical ReRAM arrays and physical analog neuron circuits.

In carrying out the present invention, a new all-analog spiking neural network (SNN) circuit is disclosed. This circuit is designed through a software-hardware codesign approach, and consists of ReRAM-crossbar synapse arrays and custom-designed spike response model (SRM) neuron circuits, built with complementary metal-oxide-semiconductor (CMOS) technology. This SNN hardware achieves 97.78% accuracy on the N-MNIST dataset, which is comparable to SOTA ANN accuracy on the MNIST dataset, using a similar number of parameters (22,360) and an experimentally calibrated model considering the ReRAM's conductance variation and the device variations of analog neuron circuits.

Meanwhile, the SNN hardware promises low latency and high energy efficiency, with an inter-spike interval of 94.75 ps and energy consumption of 1.16 pJ per spike, representing an improvement of one order of magnitude over SOTA designs (˜1 ns [31] and ˜10 pJ [32]). This hardware enables spatiotemporal recognition within 10 ns per N-MNIST sample. In comparison with other SNN implementations that have achieved accuracies of 84% [33], 91.2% [23], and 83.24% [34] on the MNIST dataset, the SNN hardware of the present invention achieves considerably higher accuracy while requiring 100× and 1,000× less inference time per sample, with energy consumption per sample being similar. This is achieved in the more challenging N-MNIST dataset with each sample size over 600× larger than that of the MNIST dataset. Furthermore, when compared with a GPU (NVIDIA GeForce 3090), the SNN implementation of the present invention exhibits 78,400× and 3,700,000× lower latency and higher energy efficiency, respectively, in classifying N-MNIST samples.

### BRIEF DESCRIPTION OF THE DRAWINGS

The foregoing and other objects and advantages of the present invention will become more apparent when considered in connection with the following detailed description and appended drawings in which like designations denote like elements in the various views, and wherein:

FIG. 1A is a schematic diagram of the SNN circuit of the present invention and FIG. 1B is an alternative, where Vin and Vout correspond to o^{(l)}(t) and s^{(l+1)}(t) in FIG. 1A, respectively;

FIG. 2A illustrates the network architecture and the implementation of a 2-layer hardware SNN with ReRAM synapse arrays and CMOS neurons according to the present invention, and FIG. 2B illustrates the chip architecture in which the upper and the lower rows implement the first layer (L1) and the second layer (L2), respectively;

FIG. 3 shows the target conductance and the readout conductance for the implementation of the two ReRAM synapse network layers where FIG. 3A shows the target conductance of the first ReRAM synapse network layer, FIG. 3B shows the readout conductance of the first ReRAM synapse network layer, FIG. 3C shows the target conductance of the second ReRAM synapse network layer and FIG. 3D shows the corresponding readout conductance of the second ReRAM synapse network layer;

FIGS. 4A-4C show the spiking neuron behaviors of the present invention during an N-MNIST sample inference, where FIG. 4A shows the post-synaptic voltage spike train (o(t), blue) and the corresponding output spike train (s(t), red), with an average spike width measured at 26.5 ns, FIG. 4B shows the corresponding membrane potential (u(t), pink) with the threshold voltage (Vth, black dash) and FIG. 4C shows the same post-synaptic voltage spike train shown in FIG. 4A (blue) accelerated and processed within 10 ns with average spike width of 45.35 ps, when simulated with 65 nm CMOS integrated circuits; and

FIGS. 5A-5E illustrate that an all-analog hardware SNN can achieve an accuracy of spatiotemporal reasoning in the N-MNIST dataset comparable to SOTA ANN algorithms, where FIG. 5A shows the classification result achieved by the experimental SNN hardware in randomly selected 200 testing samples, FIG. 5B shows the corresponding classification achieved by the simulated SNN consisting of physical ReRAM synapses and a hardware neuron model, FIG. 5C shows the accuracy, 92.40%, achieved by the experimentally-validated SNN, in 10,000 testing samples, FIG. 5D is a photograph of an experimental setup for testing the present invention and FIG. 5E shows a prototype of the two CMOS neurons implemented on printed circuit board (PCB) (left and right).

### DETAILED DESCRIPTION OF THE INVENTION

SNN learning algorithms significantly influence the accuracy and efficiency that an SNN implementation can achieve. The SNN implementations employing localized synaptic learning rules, represented by spike-timing-dependent plasticity, can achieve high efficiency, but with limited accuracy comparable to SOTA ANN counterparts.

The use of neural coding schemes to convert artificial neural networks (ANNs) to spiking neural networks (SNNs) can result in SNN implementations achieving accuracy levels close to those of ANNs. This, however, comes at the cost of efficiency, as well as the ease of capturing the temporal dynamics of neuromorphic systems and conversion approximation precision. Direct training of SNNs through spike-based error back-propagation algorithms [27]-[29] allows for the application of approaches that endow ANNs with superior performance to train SNNs. For example, [28] achieved 99.20% accuracy on N-MNIST dataset comparable to the SOTA ANN accuracy on MNIST dataset [35]. However, this algorithm suffers from the high computational complexity of unfolding in time even for inferences. Performing the inference computations on CPU and/or GPU is both time- and energy-exhausting. The present invention takes inspiration from this algorithm and serves as the foundation for the hardware SNNs that achieve comparable SOTA ANN accuracy on the N-MNIST dataset, with four orders and six orders of magnitude improvement in latency and energy efficiency compared to the software SNNs running on a GPU.

A spiking neuron maintains its internal membrane potential by accumulating input spikes over time and encodes this continuous-time membrane potential into output spikes. The Hodgkin-Huxley model [36] describes the spiking neuronal dynamics using differential equations, but this model is computationally expensive, costing 1,200 floating point operations to evaluate 1 ms of model time [37]. By contrast, the widely used leaky integrate-and-fire (LIF) neuron model is the most efficient implementation, taking only 5 floating-point operations to simulate the model for 1 ms [37]. However, the simplicity of the LIF model restricts its ability to exhibit complex spiking behaviors [37], [38], limiting the accuracy that can be achieved. SRM [39] is a simple but versatile spiking neuron model balancing biological plausibility and computational efficiency. SRM describes membrane potential by integrating kernels over incoming spikes from synapses and output spikes from the neuron itself. Appropriate kernel choices enable the SRM to approximate the Hodgkin-Huxley model with a significant increase in energy efficiency and computation speed [40]. The SNN circuits of the present invention are thus based on SRM neurons.

SNNs can be implemented with ReRAM synapses and differential pair integrator circuits [32], [41], which exhibit high energy efficiency but are characterized by relatively slow biological time constants. Accelerating to below the order of microseconds, however, requires significantly smaller capacitors approaching the parasitic capacitance of integrated circuits, making it difficult to work in accelerated time scales. BrainScaleS, a mixed-signal LIF-based SNN system [42], [43], emulates biological network activity at a speed 1,000× faster than biological time scales, enabling the simulation of long-term biological processes within a relatively shorter period. However, further acceleration is constrained by the bandwidth of the on-chip digital communication fabric and the increased power consumption of digital circuits. The operation of their system remains at the millisecond time scale. Two rate-based SNN implementations with ReRAM synapses and CMOS neurons achieved 84% [33] and 91.2% [23] accuracy in MNIST dataset, respectively. However, they lack spatiotemporal reasoning capability or the inherent SNN advantages in latency and energy efficiency.

The present invention is a fully analog hardware SNN that can achieve a comparable SOTA ANN accuracy on the N-MNIST dataset and simultaneously low latency and high energy efficiency, one order of magnitude better than SOTA designs [31], [32] as well as four orders and six orders of magnitude better than a GPU. The present hardware SNN consists of analog memory synapses and custom-designed CMOS SRM neuron circuits and can deploy the SNN model trained by backpropagation, realizing a software-equivalent accuracy.

Forward propagation of the SNN model of the present invention in a layer l with Nₗ neurons and a weight matrix W^{(l)} [w₁, w₂, . . . , w_{Nl}] is described in Eqs. 1-6:

$${o}^{( l )} ( t ) = ReLU ( {s}^{( l )} ( t ) {W}^{( l )} ) , \qquad ( 1 )$$

$${u}^{( l )} ( t ) = ( ε * {o}^{( l )} ) ( t ) - ( υ * {s}^{( l + 1 )} ) ( t ) , \qquad ( 2 )$$

$${s}^{( l + 1 )} ( t ) = {f}_{s} ( {u}^{( l )} ( t ) ) \qquad ( 3 )$$

where * is a convolution operator, s^{(l)}(t)=Σδ(t-tᵢ) is the input spike trains with tᵢ denoting the timing of the iₜₕ input spike and δ being the Dirac delta function, ReLU is the rectified linear unit, o^{(l)}(t) is the post-synaptic spike trains, ε is the response kernel accumulating the post-synaptic spike trains on membrane potential, ν is the refractory kernel for inhibiting membrane potential after firing, u^{(l)}(t) is the membrane potential, and ƒₛ is a threshold function defined as:

$${f}_{s} ( u ) : u \to s , s ( {t}_{i} ) = \{ \begin{matrix}δ ( t - {t}_{i} ) , & if u ( {t}_{i} ) \geq Vth \\ 0 , & otherwise\end{matrix} , \qquad ( 4 )$$

where Vth is the threshold. The output spike trains from the neurons are represented by s^{(l+1)}(t).

The response kernel ε and refractory kernel ν are defined below:

$$ε = \frac{1}{{τ}_{s}} {e}^{- t / {τ}_{s}} H ( t ) , \qquad ( 5 )$$

$$υ = \frac{m}{{τ}_{r}} {e}^{- t / {τ}_{r}} H ( t ) , \qquad ( 6 )$$

where H(t) represents the Heaviside step function, τₛ and τᵣ denote neuron time constants for response and refractory signals, respectively, and m is a scale factor determining the magnitude of the refractory signal.

Eq. 1 describes synapse networks that extract spatial information and Eqs. 2-6 model spiking neurons that abstract temporal information. The SNN model thus has spatiotemporal reasoning capability. Specifically, the present designed response kernel ε and refractory kernel ν enable the SNN model to have linear temporal dynamics. By shrinking the time constants of the two kernels, the time dimension of our SNN model can be scaled while maintaining the output responses, enabling the SNN system to perform accelerated spatiotemporal inferences and achieve significantly enhanced throughput. The response and refractory kernels are implemented as the simplest first-order low-pass filters to minimize the computational burden during training and the circuit overhead during inferences. More complex kernels can be adopted and implemented with the combination of resistors, capacitors and inductors, resulting in a more biologically plausible neuron model.

For classification tasks, the output neuron producing the greatest number of spikes corresponds to the inferred class. The error in spike count is used as the loss function. In the backpropagation of error, the derivative of the non-differentiable threshold function ƒₛ is approximated by a surrogate gradient, which is in the form of an exponentially decaying probability density function, and the derivative of the convolution operation is implemented by a correlation operation which accumulates the future losses up to the current time [28].

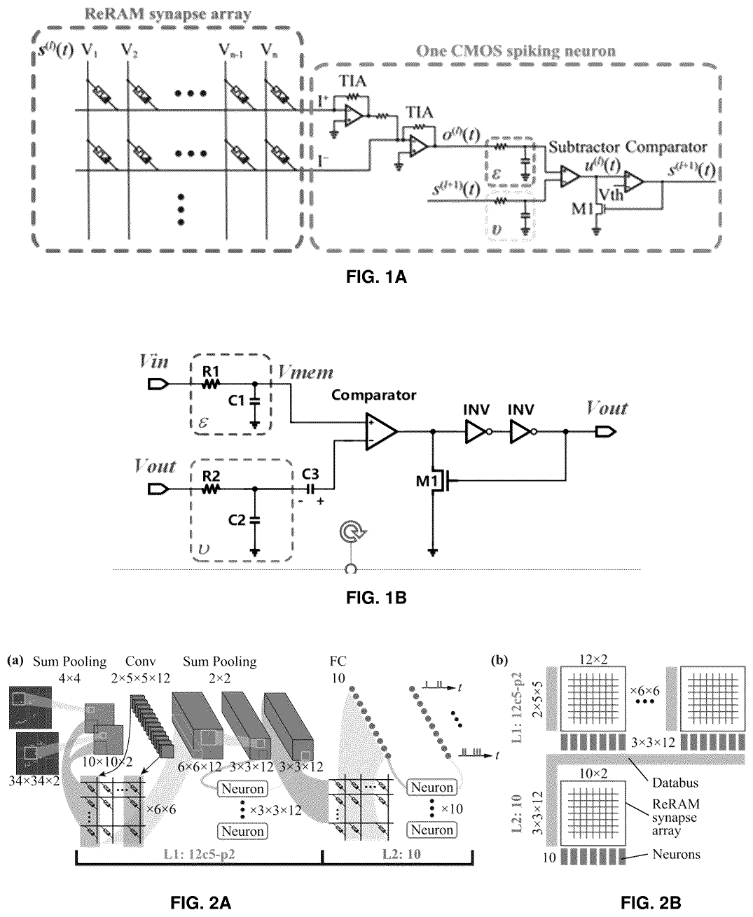

The schematic of the SNN implementation is shown in FIG. 1A. It includes a ReRAM synapse network (blue box) and a CMOS spiking neuron (red box). Trained parameters are mapped to the conductance of the ReRAM synapse array that conducts multiply-accumulate operations in parallel. Every two rows of the ReRAM array are used to represent positive and negative parameters so that the difference between the two can represent signed values. The difference in output current of the two rows is transformed into voltage signals by two transimpedance amplifiers (TIAs), completing a multiply-accumulate operation and producing a post-synaptic voltage spike train, o^{(l)}(t). The TIA2 clamps the output voltage to a positive level, functioning as a ReLU activation function enhancing the generalization of this SNN system.

The two time-linear kernels (ε and ν) of the SRM neurons are implemented as passive resistor-capacitor (RC) filters, ε filter and ν filter, which are the core computing units of the neuron circuit. The ε filter (green box in FIG. 1A) convolves the post-synaptic spike train o^{(l)}(t) with the response kernel ε and generates a spike response, implementing the integration of post-synaptic spikes onto the membrane potential and the leakage of membrane potential. The ν filter (yellow box) convolves the output spike train s^{(l+1)}(t) with a refractory kernel ν, generating a refractory response to inhibit the membrane potential when the neuron spikes. The neuron's membrane potential u^{(l)}(t) is the difference between the spike response and the refractory response. When the membrane potential crosses over the pre-defined threshold Vth, a voltage spike is sent out. This CMOS neuron circuit directly processes the output current from the ReRAM synapse array, and thus analog-to-digital converters are not required.

In operation, the neuron circuit in FIG. 1A has input currents, I⁺ and I⁻, which are transformed into voltage spike trains, o^{(l)}(t), by two TIAs. The resulting voltage spike trains then pass through the ε RC filter, highlighted by the green box, and yields the spike response. The output voltage spike train, s^{(l+1)}(t), is looped back from the output port to enter the ν RC filter, highlighted by the yellow box, giving rise to a continuous refractory response. By employing an operational amplifier-based subtractor, the refractory response is subtracted from the spike response, ultimately producing the membrane potential, u^{(l)}(t). This membrane potential is then encoded into output voltage spike trains, s^{(l+1)}(t), by a comparator and a transistor M1. When the membrane potential u^{(l)}(t) surpasses the threshold voltage Vth, the comparator generates a high voltage, turning on the transistor M1. This transistor then pulls down the positive input node of the comparator, as well as its output, leading to the generation of an output voltage spike and turning off the transistor M1.

An alternative circuit is shown in FIG. 1B. In that circuit, initially the voltage across the capacitor C3 is charged to the threshold voltage, Vth, with the positive potential on the right and the negative potential on the left. The input voltage spike train, Vin corresponding to o^{(l)}(t) in FIG. 1A, passes through the ε RC filter, highlighted by the red box, and produces the membrane potential, Vmem. The output voltage spike train, Vout corresponding to s^{(l+1)}(t) in FIG. 1A, is fed back from the output port and enters the ν RC filter, highlighted by green box, producing the refractory signal. This refractory signal is then lifted by a fixed threshold voltage, Vth, provided by the capacitor C3, resulting in a dynamic threshold voltage that connects to the negative node of the comparator, inhibiting the neuron from spiking. When the membrane potential, Vmem, exceeds the dynamic threshold voltage, the comparator generates a high voltage, turning on the transistor M1. This transistor then pulls down the comparator's output, resulting in a spike. The transistor M1 is then turned off.

A small two-layer convolutional network architecture is used to illustrate the hardware SNN that classifies moving digits in the benchmark N-MNIST dataset and to build a calibrated model for scale analysis. Each sample lasts 300 ms and the size of each sample is 2×34×34×300. The structure of the SNN model according to the present invention (FIG. 2A) is specified as 34×34×2-p4-(12c5-p2)-(10), where the 2 network layers, L1 and L2, are indicated with ‘( )’, 12c5 represents a convolution layer with 12 filters of size 5×5, p2 represents a sum pooling layer of size 2×2, and 10 represents a fully connected layer of 10 neurons. Each spatial pixel of feature maps is connected to a spiking neuron that has no parameters. This SNN model includes a total of 1,680 parameters and 118 spiking neurons. The convolutional layer is implemented by replicating the ReRAM synapse array 6×6 times to implement pixel-wise parallel convolution for spatial information extraction. A possible chip architecture of this hardware SNN is shown in FIG. 2B. This two-layer SNN model was trained on the 60,000 training samples of the N-MNIST dataset and achieved 94.92% accuracy on the 10,000 testing samples. The lower accuracy resulted from the limited parameters which made it possible to run the experiments and calibrate the model.

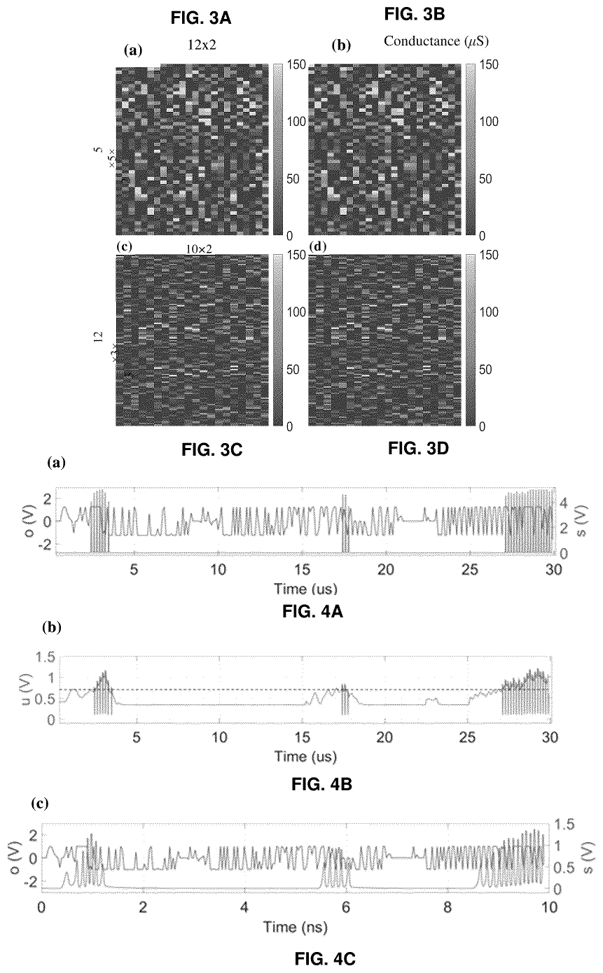

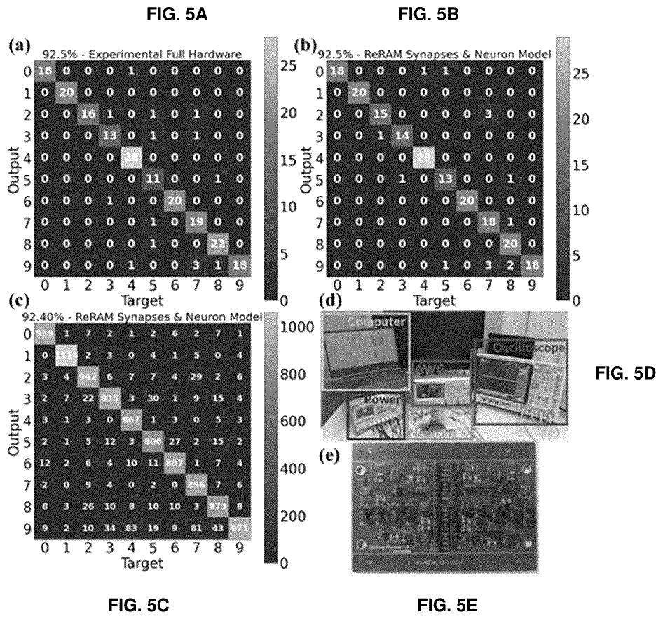

Parameters of the trained SNN model were then mapped to the conductance of the ReRAM in the synapse arrays. A total of 3,360 ReRAM devices were programmed to run three times and the readout conductance closest to the target conductance was selected. The readout conductance matched well with the target conductance, with the standard deviation of the readout conductance error being 2.49 μS (FIG. 3). The neuron circuit was implemented in a physical printed circuit board (PCB). For proof of concept, only two physical neuron circuits were built, each of which were time-multiplexed by each network layer. The setup and the neuron board is shown in FIG. 5D and FIG. 5E. During each inference, the input signals to the PCB neuron were sent from a computer and transmitted by an arbitrary waveform generator (AWG), and the output signals from the PCB neuron were measured by an oscilloscope and returned to the computer. Typical neuron behaviors are shown in FIG. 4A-4C, where FIG. 4A shows the post-synaptic voltage spike train (o(t), blue) and the corresponding output spike train (s(t), red), with an average spike width measured at 26.5 ns, FIG. 4B shows the corresponding membrane potential (u(t), pink) with the threshold voltage (Vth, black dash) and FIG. 4C shows the same post-synaptic voltage spike train (blue) accelerated and processed within 10 ns with average spike width of 45.35 ps, when simulated with the CMOS integrated circuits of 65 nm technology node. This 2-layer hardware SNN with physical ReRAM synapse and physical neuron circuits achieved 92.5% experimental accuracy (FIG. 5A), in randomly selected 200 N-MNIST testing samples.

A compact neuron model was built according to Eqs. 2-6 and the model was calibrated with the circuit structure and experimental results. An SNN consisting of the physical ReRAM synapses and the calibrated neuron model was then used to classify the same 200 N-MNIST samples in the experiment of FIG. 5A, and achieved the same classification accuracy compared to the experimental result, 92.5% (FIG. 5B). Subsequently, this experimentally-validated SNN model classified the 10,000 N-MNIST testing samples and achieved 92.40% accuracy (FIG. 5C), which is significantly higher than the accuracy, 84% [33], 91.2% [23] and 83.24% [34], achieved by the existing SOTA implementations of hardware SNN on the MNIST dataset which requires only spatial reasoning capability.

This accuracy is compared to the ideal simulations, where the synapse network and the neurons are replaced with ideal software counterparts respectively (Table. I). The accuracy of the experimentally validated SNN is 2.52% lower than the ideal software SNN. Nonidealities of ReRAM synapses and neuron circuit implementation both introduce errors into the SNN inference, resulting in a loss of accuracy. This accuracy loss is significantly smaller in larger networks.

TABLE I
Comparison of the classification accuracy of the full
hardware SNN with three software counterparts.

| | ReRAM | Software |
|---|---|---|
| | Synapses | Synapses |
| Hardware Neuron Model | 92.40% | 93.56% |
| Software Neuron | 93.71% | 94.92% |

After validating the invention with physical ReRAM and neurons, the calibrated model was used to estimate the performance when the hardware SNN is implemented with an advanced technology node for scaled problems. The linear temporal dynamics of the SNN model of the present invention allows for the easy scaling of the time dimension of input spike trains s(l)(t), so that the neurons can operate significantly faster while consuming lower energy per spike. Further, the hardware SNN was simulated in Cadence Virtuoso with the TSMC's 65 nm process development kit (PDK). The accelerated input spike train of FIG. 4A was fed into the neuron and a consistent output spike train (FIG. 4C) was produced, but at a much lower latency and higher energy efficiency with an inter-spike interval of 94.75 ps and energy per spike of 1.16 pJ, one order of magnitude better than the performance of SOTA neuron designs, ˜1 ns [31] and ˜10 pJ [32]. This enables the hardware SNN of the present invention to classify each N-MNIST sample in ˜10 ns or recognize a fleeting motion as fast as ˜10 ns. Prior existing hardware SNN cannot achieve the operation speed approaching this. With a more advanced technology node, the latency and energy efficiency can be further improved.

The latency and energy consumption was compared between the hardware SNN and the baseline software SNN running on a GPU (NVIDIA GeForce 3090) for N-MNIST classification. The entire inference of the software SNN was performed on one GPU, and the NVIDIA System Management Interface tool was used to estimate the energy consumed by the software SNN. The energy consumed by the hardware SNN was estimated in Cadence Virtuoso with the TSMC's 65 nm design rules. The middle two columns of Table. II show that the baseline software SNN took an average of 504.65 ps to classify each sample, while the hardware SNN spent ˜10.1 ns. The corresponding energy per sample consumed by the software SNN is 42.31 mJ, of which the calculation of synapse networks covers most. By contrast, the hardware SNN took only 3.39 nJ for each sample, of which L1 neurons consumed the vast majority. The hardware SNN of the present invention spent 50,000× less time and 12,500,000× less energy than the GPU. For the hardware SNN, ReRAM synapse arrays consumed a negligible portion of energy because of the passive nature of the ReRAM devices and the narrow spike width, ˜45.35 ps. Also, most of the energy was dissipated in the first layer (L1) neurons because (1) the neuron circuits of the present invention include active operational amplifiers; and (2) L1 neurons generate significantly more spikes than subsequent layer neurons, resulting in more energy consumption.

TABLE II
Comparison of time and energy consumption between the
hardware (HW) SNN and the baseline software (SW) SNN

| | HW | SW | HW | SW |
|---|---|---|---|---|
| | (2 Layers) | (2 Layers) | (3 Layers) | (3 Layers) |
| Accuracy | 92.40% | 94.92% | 97.78% | 98.70% |
| Time/sample (μs) | 0.0101 | 504.6537 | 0.0102 | 799.2206 |
| Energy/sample (mJ) | 3.3926e−6 | 42.3062 | 2.1603e−5 | 79.1784 |
| Synapses (mJ) | 9.0500e−9 | 18.7315 | 1.6375e−7 | 32.3831 |
| L1 neurons (mJ) | 3.2681e−6 | 14.7739 | 1.5681e−5 | 18.6435 |
| L2 neurons (mJ) | 1.1549e−7 | 8.8008 | 5.6476e−6 | 17.6616 |
| L3 neurons (mJ) | — | — | 1.1070e−7 | 10.4902 |

To demonstrate that the hardware SNN of the invention can achieve higher accuracy, the SNN model was expanded from 2 layers to 3 layers, with a structure: 34×34×2-p2-(12c5-p2)-(64c5-p2)-(10). The number of parameters was increased to 22,360, and the number of neurons was 1,034. This 3-layer software SNN was trained on 60,000 N-MNIST training samples and the accuracy improved to 98.70% on 10,000 testing samples. Due to the limited size of the physical ReRAM array, the 3-layer ReRAM synapse network was simulated by sampling the readout conductance error of the experimentally programmed ReRAM devices. The distribution of sampled error was consistent with the distribution of readout error. Also, the identical hardware neuron model to that in the experimentally-validated SNN was used. This 3-layer hardware SNN achieved 97.78% accuracy in the 10,000 N-MNIST testing samples, 0.92% lower than the corresponding ideal software SNN. Compared to the accuracy loss in the first small 2-layer network, this accuracy loss is smaller in the large network, and expect to reduce further with an even larger network. The right two columns of Table II show this 3-layer hardware SNN takes 78,400× less time and 3,700,000× less energy than the baseline.

The hardware SNNs were also compared with SOTA SNN implementations in Table III. The SNN implementation of the present invention achieves significantly higher accuracy in the N-MNIST dataset than the others in the MNIST dataset. It is worth noting that classifying N-MNIST samples is more challenging than classifying MNIST samples since the network must have the spatiotemporal reasoning capability to manage saccadic movements. Also, each N-MNIST sample is over 600× larger than the MNIST sample. However, the present implementations achieve significantly faster classification per sample, two orders of magnitude faster than the others, and consumed similar energy per sample.

TABLE III
Comparison with SOTA SNN implementations.

| | | | | | Energy | | Time | | | | |
|---|---|---|---|---|---|---|---|---|---|---|---|
| | Accuracy | | | Sample | per | | per | | | | |
| | (samples) | Parameters | Benchmark | size | sample | | sample | | Node | | Algorithm |
| [33] | 84% | 1,440 | MNIST | 28 × 28 | 24.48 | nJ | — | | 130 | nm | Rate coding |
| | (10,000) | | | | | | | | | | |
| [23] | 91.2% | 1.96G | MNIST | 28 × 28 | 3.5 | nJ | 1 | μs | — | | Rate coding |
| | (1,000) | | | | | | | | | | |
| [34] | 83.24% | 784K | MNIST | 28 × 28 | 3.5 | μJ | 10 | μs | — | | Rate coding |
| | (10,000) | | | | | | | | | | |
| Ours | 97.78% | 22,360 | N-MNIST | 2 × 34 × | 21.6 | nJ | 10.2 | ns | 65 | nm | Backpropagation |
| 3 Ls | (10,000) | | | 34 × 300 | | | | | | | |
| Ours | 92.40% | 1,680 | N-MNIST | 2 × 34 × | 3.4 | nJ | 10.1 | ns | 65 | nm | Backpropagation |
| 2 Ls | (10,000) | | | 34 × 300 | | | | | | | |

Rather than following the conventional bottom-up approach, the present hardware SNNs were designed with a top-down approach. Inspired by a SOTA SNN training algorithm [28], the neuron model was designed in the form of the simplest first-order low-pass filter. The hardware SNNs were then designed based on the approximate physical characteristics of devices, a so-called top-down approach. This top-down design methodology resulted in hardware SNNs that demonstrate performance comparable to SOTA ANN algorithms and significantly outperform the hardware SNNs developed through the bottom-up approach. The 2-layer and 3-layer hardware SNNs of the present invention achieve 92.40% and 97.78% accuracy on 10,000 N-MNIST testing samples, respectively, comparable to SOTA ANN accuracy. Using larger network structures with more learnable parameters, these hardware SNNs can achieve even better accuracy.

Besides the comparable ANN accuracy, the hardware SNNs of the invention can simultaneously achieve low latency and high energy efficiency. Its neurons can spike at the inter-spike interval of 94.75 ps and at 1.16 pJ energy per spike, one order of magnitude better than SOTA neuron designs [31], [32]. The neuron circuit is designed to have linear dynamics over time. By scaling down the time constants of the two filters, the SNN system can process an accelerated input event stream, enhancing the throughput and reducing the total energy consumption. Meanwhile, the capacitance and resistance required to realize the RC filters can be significantly reduced, avoiding the problem of large component size restricting large-scale integration. The high energy efficiency is attributed to two reasons: (1) the core computing units of the neuron circuit are implemented by passive RC filters; and (2) the spiking neurons can operate at a very high speed, significantly reducing the inference time, and hence the energy consumed. Using advanced technology nodes, such as 28 nm, the latency and energy efficiency can be further improved. Besides, memristive devices [44] and memcapacitive devices [45], [46] can be used to implement the resistors and the capacitors of the two RC filters, resulting in tunable time constants. Thus, a flexible inference speed can be achieved.

The killer applications of SNNs have not been as extensively and intensively investigated as those of ANNs. Performing inferences of SNNs on current CPU and/or GPU computing systems is both time- and energy-consuming. The proposed neuromorphic systems of the present invention can accelerate SNN inferences just as GPUs accelerate ANN inferences, thereby facilitating the search for killer applications of SNNs. The neuromorphic systems can also be used to study neuroscience by performing large-scale biologically plausible simulations faster and more energy-efficiently than conventional von Neumann computing systems. They pave the way toward analog neuromorphic processors for complex real-world tasks.

The present invention provides consistent and reliable spiking behavior. An RC filter consisting of two passive analog components is used to implement the neuron operations of integration and leaking. Functioning as a low-pass filter, the RC filter filters out the inevitable high-frequency noises in integrated circuits, resulting in stable spiking behavior. The passive resistor and capacitor composing this RC filter are also considerably more endurable than the subthreshold-operated MOSFET structures as well as emerging memories/devices and materials in other spiking neuron designs.

In addition, the present invention has scalability for large-scale integration. The neuron operations of integration and leaking are implemented by an RC filter consisting of only two components without any control circuits, and the capacitor size can be significantly reduced, approaching the limit of parasitic capacitance. The spiking neuron design thus has a comparable packing density to that of the current scalable CMOS neuron designs.

In summary, the invention demonstrates that all-analog hardware SNNs can achieve an accuracy comparable to SOTA ANN algorithms on the N-MNIST dataset. The hardware SNNs of the present invention consist of ReRAM synapse arrays and CMOS neuron circuits and can perform accelerate-time inferences at high rates and energy efficiency, with inter-spike interval 94.75 ps and 1.16 pJ energy per spike, enabling the recognition of spatiotemporal patterns within ˜10 ns. This SNN implementation achieves 97.78% accuracy on the N-MNIST dataset and each inference takes 78,400× less time and 3,700,000× less energy than the baseline software SNN running on a GPU (NVIDIA GeForce 3090). Compared with SOTA SNN implementations on MNIST dataset, the present invention achieves significantly higher accuracy on the more difficult N-MNIST dataset. Also, this SNN implementation spends two orders of magnitude less time and consume similar energy to classify each N-MNIST sample that are over 600× larger in size than each MNIST sample.

### REFERENCES

The cited references in this application are incorporated herein by reference in their entirety and are as follows:
[1] G. Tang et al., “Reinforcement co-learning of deep and spiking neural networks for energy-efficient mapless navigation with neuromorphic hardware,” in IROS. IEEE, 2020, pp. 6090-6097.
[2] R. K. Stagsted et al., “Event-based PID controller fully realized in neuromorphic hardware: a one DoF study,” in IROS. IEEE, 2020, pp. 10939-10944.
[3] L. E. Shupe et al., “Neurochip3: an autonomous multichannel bidirectional brain-computer interface for closed-loop activity-dependent stimulation,” Frontiers in Neuroscience, vol. 15, 2021.
[4] F. Boi et al., “A bidirectional brain-machine interface featuring a neuromorphic hardware decoder,” Frontiers in Neuroscience, vol. 10, p. 563, 2016.
[5] P. A. Merolla et al., “A million spiking-neuron integrated circuit with a scalable communication network and interface,” Science, vol. 345, pp. 668-673, 2014.
[6] M. Davies et al., “Loihi: A neuromorphic manycore processor with on chip learning,” IEEE Micro, vol. 38, pp. 82-99, 2018.
[7] J. Pei et al., “Towards artificial general intelligence with hybrid tianjic chip architecture,” Nature, vol. 572, pp. 106-111, 2019.
[8] B. V. Benjamin et al., “Neurogrid: A mixed-analog-digital multichip system for large-scale neural simulations,” Proceedings of the IEEE, vol. 102, pp. 699-716, 2014.
[9] S. B. Furber et al., “The SpiNNaker project,” Proceedings of the IEEE, vol. 102, pp. 652-665, 2014.
[10] J. Schemmel et al., “A wafer-scale neuromorphic hardware system for large-scale neural modeling,” in ISCAS. IEEE, 2010, pp. 1947-1950.
[11] C. Mead, “Neuromorphic electronic systems,” Proceedings of the IEEE, vol. 78, pp. 1629-1636, 1990.
[12]Z. Wang et al., “Fully memristive neural networks for pattern classification with unsupervised learning,” Nature Electronics, vol. 1, pp. 137-145, 2018.
[13] J. Wang et al., “Handwritten-digit recognition by hybrid convolutional neural network based on HfO2 memristive spiking-neuron,” Scientific Reports, vol. 8, pp. 1-7, 2018.
[14] J.-N. Huang et al., “Adaptive SRM neuron based on NbOx memristive device for neuromorphic computing,” Chip, vol. 1, p. 100015, 2022.
[15] T. Tuma et al., “Stochastic phase-change neurons,” Nature Nanotechnology, vol. 11, pp. 693-699, 2016.
[16] M. E. Beck et al., “Spiking neurons from tunable Gaussian heterojunction transistors,” Nature Communications, vol. 11, pp. 1-8, 2020.
[17]Z. Wang et al., “Experimental demonstration of ferroelectric spiking neurons for unsupervised clustering,” in IEDM. IEEE, 2018, pp. 13-3.
[18] S. Dutta et al., “Leaky integrate and fire neuron by charge-discharge dynamics in floating-body MOSFET,” Scientific Reports, vol. 7, pp. 1-7, 2017.
[19] T. Chavan et al., “Band-to-band tunneling based ultra-energy-efficient silicon neuron,” T-ED, vol. 67, pp. 2614-2620, 2020.
[20] V. K. Sangwan et al., “Multi-terminal memtransistors from polycrystalline monolayer molybdenum disulfide,” Nature, vol. 554, pp. 500-504, 2018.
[21] K. Kim et al., “A carbon nanotube synapse with dynamic logic and learning,” Advanced Materials, vol. 25, pp. 1693-1698, 2013.
[22] J. Jiang et al., “2D MoS2 neuromorphic devices for brain-like computational systems,” Small, vol. 13, p. 1700933, 2017.
[23] T. Tang et al., “Spiking neural network with RRAM: Can we use it for real-world application?” in DATE. IEEE, 2015, pp. 860-865.
[24] B. Rueckauer et al., “Conversion of continuous-valued deep networks to efficient event-driven networks for image classification,” Frontiers in Neuroscience, vol. 11, p. 682, 2017.
[25] A. Sengupta et al., “Going deeper in spiking neural networks: VGG and residual architectures,” Frontiers in Neuroscience, vol. 13, p. 95, 2019.
[26] S. Kim et al., “Spiking-YOLO: Spiking neural network for energy efficient object detection,” in AAAI, vol. 34, no. 07, 2020, pp. 11270-11277.
[27] J. H. Lee et al., “Training deep spiking neural networks using backpropagation,” Frontiers in Neuroscience, vol. 10, p. 508, 2016.
[28] S. B. Shrestha et al., “Slayer: Spike layer error reassignment in time,” NeurIPS, vol. 31, 2018.
[29] E. O. Neftci et al., “Surrogate gradient learning in spiking neural networks: Bringing the power of gradient-based optimization to spiking neural networks,” IEEE Signal Processing Magazine, vol. 36, pp. 51-63, 2019.
[30] G. Orchard et al., “Converting static image datasets to spiking neuromorphic datasets using saccades,” Frontiers in Neuroscience, vol. 9, p. 437, 2015.
[31] I. Chakraborty et al., “Toward fast neural computing using all-photonic phase change spiking neurons,” Scientific Reports, vol. 8, pp. 1-9, 2018.
[32] M. V. Nair et al., “An ultra-low power sigma-delta neuron circuit,” in ISCAS. IEEE, 2019, pp. 1-5.
[33] A. Valentian et al., “Fully integrated spiking neural network with analog neurons and RRAM synapses,” in IEDM. IEEE, 2019, pp. 14-3.
[34] Q. Duan et al., “Spiking neurons with spatiotemporal dynamics and gain modulation for monolithically integrated memristive neural networks,” Nature Communications, vol. 11, pp. 1-13, 2020.
[35] S. An et al., “An ensemble of simple convolutional neural network models for MNIST digit recognition,” arXiv preprint arXiv:2008.10400, 2020.
[36] A. L. Hodgkin et al., “A quantitative description of membrane current and its application to conduction and excitation in nerve,” The Journal of Physiology, vol. 117, p. 500, 1952.
[37] E. M. Izhikevich, “Which model to use for cortical spiking neurons?” IEEE Transactions on Neural Networks, vol. 15, pp. 1063-1070, 2004.
[38] ______, “Simple model of spiking neurons,” IEEE Transactions on Neural Networks, vol. 14, pp. 1569-1572, 2003.
[39]W. Gerstner, “Time structure of the activity in neural network models,” Physical Review E, vol. 51, p. 738, 1995.
[40] I.-M. Comsa̧et al., “Temporal coding in spiking neural networks with alpha synaptic function: learning with backpropagation,” IEEE Transactions on Neural Networks and Learning Systems, 2021.
[41] G. Indiveri et al., “Integration of nanoscale memristor synapses in neuromorphic computing architectures,” Nanotechnology, vol. 24, p. 384010, 2013.
[42] S. A. Aamir et al., “A highly tunable 65-nm CMOS LIF neuron for a large scale neuromorphic system,” in ESSCIRC. IEEE, 2016, pp. 71-74.
[43] ______, “An accelerated LIF neuronal network array for a large-scale mixed-signal neuromorphic architecture,” TCAS-I, vol. 65, pp. 4299-4312, 2018.
[44] J. J. Yang et al., “Memristive devices for computing,” Nature Nanotechnology, vol. 8, pp. 13-24, 2013.
[45] M. Di Ventra et al., “Circuit elements with memory: memristors, memcapacitors, and meminductors,” Proceedings of the IEEE, vol. 97, pp. 1717-1724, 2009.
[46] K.-U. Demasius et al., “Energy-efficient memcapacitor devices for neuromorphic computing,” Nature Electronics, vol. 4, pp. 748-756, 2021.

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

We claim:

1. An all-analog spiking neural network (SNN) circuit comprising:
at least one ReRAM-crossbar synapse array that conducts multiply-accumulate operations in parallel; and
a spike response model (SRM) neuron circuit, built with complementary metal-oxide-semiconductor (CMOS) technology, that receives outputs from the ReRAM-crossbar synapse array and directly processes the output currents from the ReRAM-crossbar synapse arrays to produce output voltage spike trains.

2. The all-analog spiking neural network circuit according to claim 1, wherein the SNN is designed according to a top-down approach.

3. The all-analog spiking neural network circuit according to claim 1, wherein the SRM is a spiking neuron model balancing biological plausibility and computational efficiency that describes a membrane potential by integrating kernels over incoming spikes from synapses and outgoing spikes from the neuron itself, wherein appropriate kernel choices enable the SRM to approximate the Hodgkin-Huxley model with a significant increase in energy efficiency and computation speed.

4. The all-analog spiking neural network circuit according to claim 1 wherein trained parameters are mapped to the conductance of the ReRAM synapse array and the SNN model is trained by backpropagation.

5. The all-analog spiking neural network circuit according to claim 1, comprising
a convolution layer formed with the ReRAM-crossbar synapse arrays,
a sum pooling layer formed by interconnecting outputs of the ReRAM-crossbar synapse arrays, followed by the CMOS neuron circuits, and
a fully connected layer formed with the ReRAM-crossbar synapse arrays, followed by the CMOS neuron circuits.

6. The all-analog spiking neural network circuit according to claim 1, wherein each of the ReRAM-crossbar synapse array has multiple pairs of rows that represent positive and negative parameters so that a difference between every two rows can represent signed values.

7. The all-analog spiking neural network circuit according to claim 6, wherein the difference in output current of the pairs of rows is transformed into voltage signals by two transimpedance amplifiers, completing the multiply-accumulate operation and producing the post-synaptic voltage spike train.

8. The all-analog spiking neural network circuit according to claim 1, wherein
each of the CMOS neuron circuits contains two resistor-capacitor filters consisting of an ε filter and a ν filter,
the ε filter is configured to implement a spike response, which is the response of membrane potential to input spikes, by convolving the input post-synaptic spike train with a response kernel ε; and
the ν filter is configured to implement a refractory response, which is the response of the membrane potential to output spikes, by convolving the output spike train with a refractory kernel ν.

9. The all-analog spiking neural network circuit according to claim 6, wherein
the membrane potential is obtained as a difference between the spike response and the refractory response, and
when the membrane potential exceeds a pre-defined threshold, a voltage spike is sent out.

9. The all-analog spiking neural network circuit according to claim 8, wherein during operation
the post-synaptic voltage spike train, o^{(l)}(t), passing through the ε resistor-capacitor (RC) filter yields a spike response and the output voltage spike train, s^{(l+1)}(t), is fed back from the output port to enter the ν RC filter and produce a refractory response;
the refractory response is subtracted from the spike response via an operational amplifier;
the membrane potential, u^{(l)}(t), is then obtained and encoded into an output voltage spike train, s^{(l+1)}(t), by a comparator and a transistor M1;
when the membrane potential, u^{(l)}(t), crosses over a threshold voltage Vth, the comparator generates a high voltage, turning on the transistor M1, which pulls down the positive input node of the comparator and the output of this comparator, thus turning off the transistor M1 so a spike is generated and output; and.
the output spike, s^{(l+1)}(t), is fed back into the ν RC filter to generate the refractory response, continuously inhibiting the membrane potential, u^{(l)}(t).

10. The all-analog spiking neural network circuit according to claim 8, wherein during operation
the input voltage spike train, Vin, passes through the ε resistor-capacitor (RC) filter, and yields the membrane potential, Vmem;
the output voltage spike train, Vout, is fed back from the output port and enters the ν RC filter and produces the refractory response that is then lifted by a fixed threshold voltage, Vth, provided by a capacitor C3, resulting in a dynamic threshold voltage connecting to the negative node of the comparator;
when the membrane potential, Vmem, crosses over the dynamic threshold voltage, a comparator generates a high voltage, turning on the transistor M1, which pulls down the output of the comparator and turns off the transistor M1; so that a spike is generated and output; and
the output spike, Vout, is looped back into the ν RC filter to generate the refractory response, increasing the dynamic threshold voltage and thus inhibiting the neuron from spiking.

11. A method of implementing inference using the all-analog spiking neural network circuit according to claim 1, said method comprising the steps of:
conducting a multiply-accumulate operation in parallel on the ReRAM-crossbar synapse array;
using every pair of rows of the ReRAM-crossbar synapse array to represent positive and negative parameters so that a difference between the two rows of each pair can represent signed values;
transforming the difference in output current of the two rows of each pair into voltage signals by two transimpedance amplifiers;
completing the multiply-accumulate operation and producing a post-synaptic voltage spike train;
sending the post-synaptic voltage spike train from a computer to the CMOS neuron circuits via an arbitrary waveform generator,
measuring the output voltage spike train from the CMOS neuron circuits with an oscilloscope; and
returning the measured output spike train from the oscilloscope to the computer.

12. A method of implementing inference comprising the steps of:
conducting a multiply-accumulate operation in parallel on a synapse array;
using every pair of rows of the synapse array to represent positive and negative parameters so that a difference between the two rows of each pair can represent signed values;
transforming the difference in output current of the two rows of each pair into voltage signals using two transimpedance amplifiers;
completing the multiply-accumulate operation and producing a post-synaptic voltage spike train;
sending the post-synaptic voltage spike train to neuron circuits via an arbitrary waveform generator,
measuring the output voltage spike train from the neuron circuits; and
returning the measured output spike train to the computer.

13. An all-analog spiking neural network circuit, comprising:
a convolution layer,
a fully connected layer formed by interconnecting outputs of the convolution layer; and
neuron circuits receiving the outputs of the interconnected layer, wherein the neuron circuits are repeated N times.
